(19) United States
(12) Patent Application Publication
(10) Pub. No.: US 2013/0050521 A1
(43) Pub. Date: Feb. 28, 2013

(54) ELECTRONIC CAMERA

(71) Applicant: Masayoshi Okamoto, Daito-shi (JP)

(72) Inventor: Masayoshi Okamoto, Daito-shi (JP)

(73) Assignee: SANYO ELECTRIC CO., LTD., Osaka (JP)

(21) Appl. No.: 13/584,044

(22) Filed: Aug. 13, 2012

(30) Foreign Application Priority Data
Aug. 26, 2011 (JP) 2011-185027

(51) Int. Cl. H04N 5/228

(52) U.S. Cl. 348/222.1

(57) ABSTRACT

An electronic camera includes an imager. An imager repeatedly outputs an image representing a scene. A register registers relative position information in response to a registering operation. A searcher searches for a predetermined site image representing a predetermined site forming a specific object, from the image outputted from the imager. A detector detects a reference position on the specific object image appearing on the image outputted from the imager, based on the predetermined site image searched out by the searcher and the relative position information registered by the register. An adjuster adjusts an imaging condition, out of the image outputted from the imager, based on a partial image present at the reference position detected by the detector.

### CROSS REFERENCE OF RELATED APPLICATION

The disclosure of Japanese Patent Application No. 2011-185027, which was filed on Aug. 26, 2011, is incorporated herein by reference.

### BACKGROUND OF THE INVENTION

1. Field of the Invention

The present invention relates to an electronic camera, and in particular, relates to an electronic camera which adjusts an imaging condition based on an optical image generated on an imaging surface.

2. Description of the Related Art

According to one example of this type of camera, an image representing a face is detected from among images photographed through an imaging lens having an autofocus processor which automatically sets a focus position to a face when the face is detected. At a time of the detection, it is determined whether or not an imaging state when imaging the face satisfies an appropriate imaging condition. When it is determined that the imaging state satisfies the appropriate imaging condition, a focusing operation by the autofocus processor is executed so that the focus position is set to the above-described face. On the other hand, when it is determined that the imaging state does not satisfy the appropriate imaging condition, the focusing operation by the autofocus processor is not executed.

However, the above-described camera describes only the detected face as a target subject to the focusing operation by the autofocus processor. Therefore, a focus adjustment needs to be manually performed on an object that cannot be detected by a dictionary image, for example, and one portion thereof, and it is not possible to respond to a fast-moving object, resulting in a possibility that a capability of adjusting the imaging condition deteriorates.

### SUMMARY OF THE INVENTION

An electronic camera according to the present invention, comprises: an imager which repeatedly outputs an image representing a scene; a register which registers relative position information in response to a registering operation; a searcher which searches for a predetermined site image representing a predetermined site forming a specific object, from the image outputted from the imager; a detector which detects a reference position on a specific object image appearing on the image outputted from the imager, based on the predetermined site image searched out by the searcher and the relative position information registered by the register; and an adjuster which adjusts an imaging condition, based on a partial image present at the reference position detected by the detector out of the image outputted from the imager.

According to the present invention, an imaging control program, which is recorded on a non-temporary recording medium in order to control an electronic camera provided with an imager which repeatedly outputs an image indicating a scene, causing a processor of the electronic camera to execute: a registering step of registering relative position information in response to a registering operation; a searching step of searching for a predetermined site image representing a predetermined site forming a specific object, from the image outputted from the imager; a detecting step of detecting a reference position on the specific object image appearing on the image outputted from the imager, based on the predetermined site image searched out by the searching step and the relative position information registered by the registering step; and an adjusting step of adjusting an imaging condition, based on a partial image present at the reference position detected by the detecting step out of the image outputted from the imager.

According to the present invention, an imaging control method, which is executed by an electronic camera provided with an imager which repeatedly outputs an image indicating a scene, comprises: a registering step of registering relative position information in response to a registering operation; a searching step of searching for a predetermined site image representing a predetermined site forming a specific object, from the image outputted from the imager; a detecting step of detecting a reference position on the specific object image appearing on the image outputted from the imager, based on the predetermined site image searched out by the searching step and the relative position information registered by the registering step; and an adjusting step of adjusting an imaging condition, based on a partial image present at the reference position detected by the detecting step out of the image outputted from the imager.

The above described characteristics and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a configuration of a dictionary referred to in an embodiment of FIG. 2;

FIG. 4 is an illustrative view showing one example of a region setting screen displayed in a region registering task;

FIG. 5 is an illustrative view showing one portion of the process of the region registering task;

FIG. 6 is an illustrative view showing one example of a table referred to in the region registering task a small bird detecting task;

FIG. 7 is an illustrative view showing one example of an allocation state of an evaluation area on an imaging surface;

FIG. 8 is an illustrative view showing one example of a detection frame used in an entire body detecting process;

FIG. 9 is an illustrative view showing one example of a configuration of a dictionary referred to in the entire body detecting process;

FIG. 10 is an illustrative view showing one portion of the entire body detecting process;

FIG. 11 is an illustrative view showing one example of a configuration of a register referred to in the entire body detecting process;

FIG. 12 is an illustrative view showing one example of a configuration of another register referred to in the entire body detecting process;

FIG. 13 is an illustrative view showing another portion of the entire body detecting process;

FIG. 14 is an illustrative view showing one example of a detection frame used in a head portion detecting process;

FIG. 15 is an illustrative view showing one example of a configuration of a register referred to in the head portion detecting process;

FIG. 16 is an illustrative view showing one portion of the head portion detecting process;

FIG. 17 is an illustrative view showing one example of a detection frame used in an eye detecting process;

FIG. 18 is an illustrative view showing one example of a configuration of a dictionary referred to in the eye detecting process;

FIG. 19 is an illustrative view showing one example of a configuration of a register referred to in the eye detecting process;

FIG. 20 is an illustrative view showing one portion of the eye detecting process;

FIG. 21 is an illustrative view showing one portion of a process of a small bird detecting task;

FIG. 22 is an illustrative view showing one example of a register referred to in an imaging task and the small bird detecting task;

FIG. 23 is an illustrative view showing one example of an image displayed on an LCD monitor in the imaging task;

FIG. 24 is a flowchart showing one portion of an operation of a CPU applied to the embodiment of FIG. 2;

FIG. 25 is a flowchart showing another portion of the operation of the CPU applied to the embodiment of FIG. 2;

FIG. 26 is a flowchart showing still another portion of the operation of the CPU applied to the embodiment of FIG. 2;

FIG. 27 is a flowchart showing yet another portion of the operation of the CPU applied to the embodiment of FIG. 2;

FIG. 28 is a flowchart showing another portion of the operation of the CPU applied to the embodiment of FIG. 2;

FIG. 29 is a flowchart showing still another portion of the operation of the CPU applied to the embodiment of FIG. 2;

FIG. 30 is a flowchart showing yet another portion of the operation of the CPU applied to the embodiment of FIG. 2;

FIG. 31 is a flowchart showing another portion of the operation of the CPU applied to the embodiment of FIG. 2;

FIG. 32 is a flowchart showing still another portion of the operation of the CPU applied to the embodiment of FIG. 2;

FIG. 33 is a flowchart showing yet another portion of the operation of the CPU applied to the embodiment of FIG. 2;

FIG. 34 is a flowchart showing another portion of the operation of the CPU applied to the embodiment of FIG. 2;

FIG. 35 is a flowchart showing still another portion of the operation of the CPU applied to the embodiment of FIG. 2;

FIG. 36 is a flowchart showing yet another portion of the operation of the CPU applied to the embodiment of FIG. 2;

FIG. 37 is a flowchart showing another portion of the operation of the CPU applied to the embodiment of FIG. 2; and

FIG. 38 is a block diagram showing a basic configuration of another embodiment of the present invention.

### DETAILED DESCRIPTION OF THE PREFERRED EMBODIMENTS

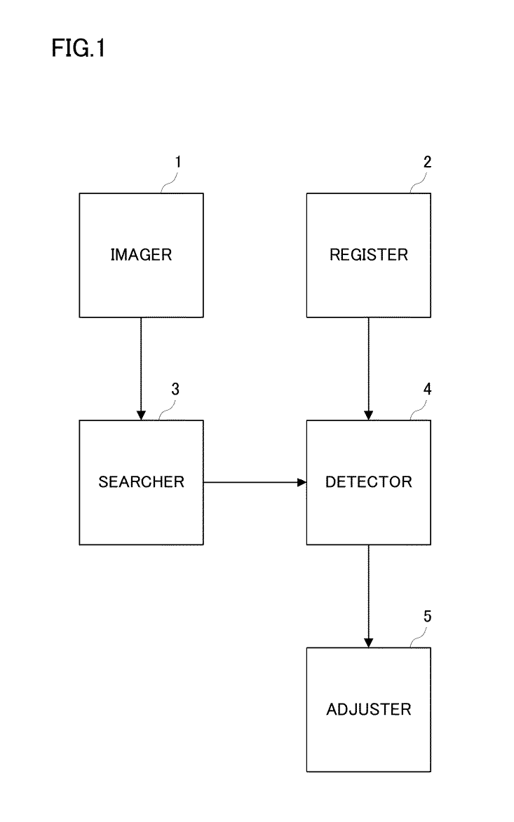

With reference to FIG. 1, an electronic camera according to one embodiment of the present invention is basically configured as follows: An imager 1 repeatedly outputs an image representing a scene. A register 2 registers relative position information in response to a registering operation. A searcher 3 searches for a predetermined site image representing a predetermined site forming a specific object, from the image outputted from the imager. A detector 4 detects a reference position on the specific object image appearing on the image outputted from the imager, based on the predetermined site image searched out by the searcher and the relative position information registered by the register. An adjuster 5 adjusts an imaging condition, out of the image outputted from the imager, based on a partial image present at the reference position detected by the detector.

The relative position information is registered in response to the registering operation. Furthermore, the predetermined site image is searched from the image outputted from the imager 1. Based on the searched-out predetermined site image and the registered relative position information, the reference position on the specific object image appearing on the image outputted from the imager 1 is detected. Based on the partial image present at the detected reference position, out of the image outputted from the imager 1, the imaging condition is adjusted.

Therefore, even in a case of a partial image that it is difficult to search directly, it is possible to adjust an imaging condition based on the partial image, and this serves to improve a capability of adjusting the imaging condition.

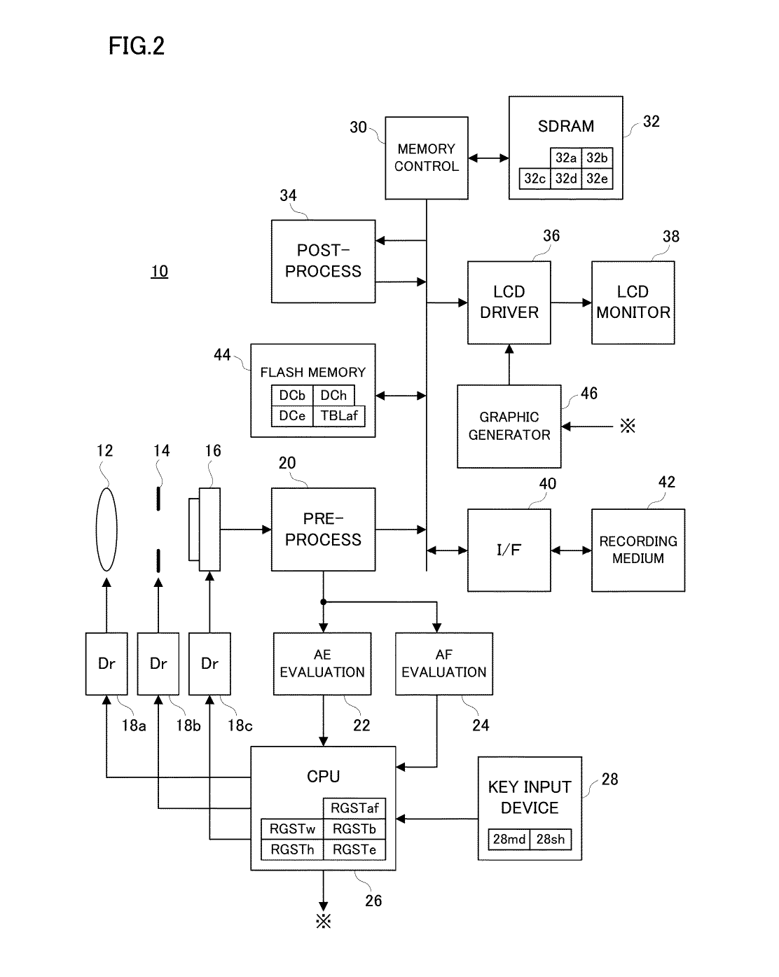

With reference to FIG. 2, when a digital camera 10 of this embodiment is activated, a CPU 26 determines a state (that is, an operation mode at a current time point) of a mode change button 28md provided in a key input device 28, under a main task. As a result of the determination, an imaging task, a region registering task, or a reproducing task are activated, corresponding to an imaging mode, an AF region registering mode, and a reproducing mode, respectively.

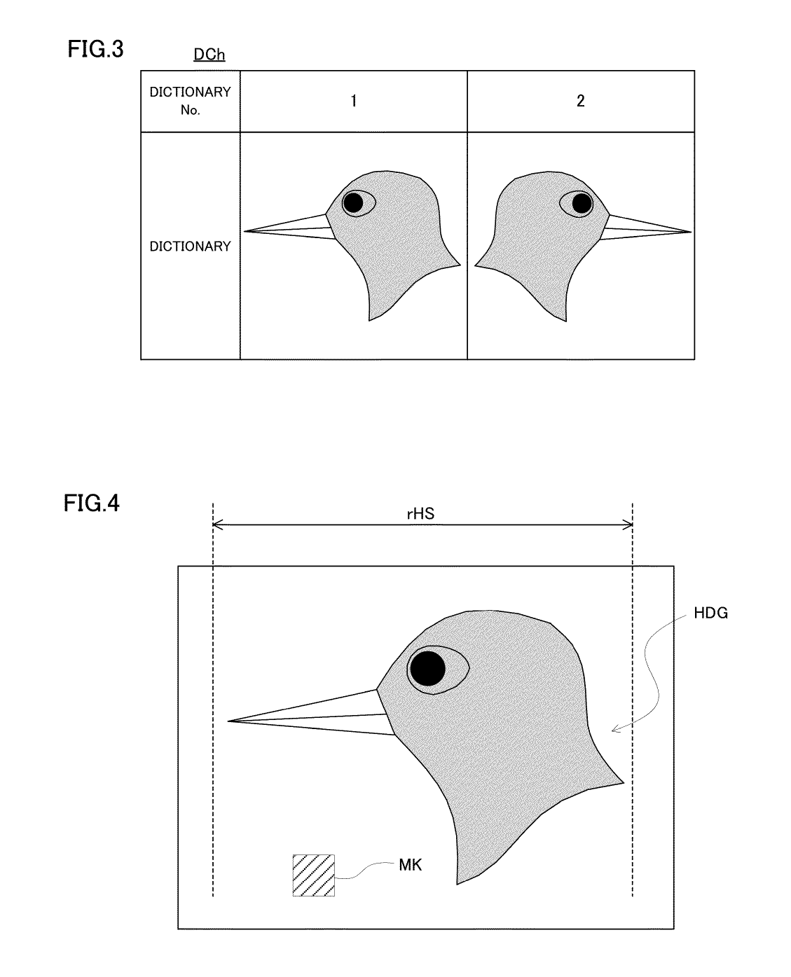

In the region registering task, a region where an AF process is to be executed in the imaging task at a time of photographing a small bird by using the digital camera 10 is registered in advance, as a relative region, by an operation of an operator. When such a region registering task is activated, the CPU 26 reads out dictionary image data having a dictionary number 1 in a head portion dictionary DCh, shown in FIG. 3, and gives an LCD driver 36 a command to display a region setting screen. The LCD driver 36 drives an LCD monitor 38 based on the read-out dictionary image data. As a result, the region setting screen shown in FIG. 4 is displayed on the LCD monitor 38.

It is noted that the head portion dictionary DCh contains two dictionary images each showing a head portion of a small bird facing right or left. Moreover, the head portion dictionary DCh is saved in a flash memory 44, and used also in a head portion detecting process described later.

On the region setting screen, a head portion dictionary image HDG and a marker MK are displayed. In the marker MK, each of a display size and a display position is changed through the key input device 28 by an operation of the operator, and a region occupied by the marker MK indicates the region where the AF process is to be performed.

The operator operates such a marker MK so as to designate a region where the AF process is to be performed at a time of photographing a small bird, that is, a region where a focus is desirably set. For example, when a focus is set to an eye of a small bird by narrowly setting a depth of field, a sharpness of an image of a trunk of a body of the small bird deteriorates. In light of this, the process of the region registering task is described by using an example where a beak positioned at an infinity-side slightly away from the eye is the region where the AF process is to be performed.

When the registering operation is performed through the key input device 28, with reference to FIG. 4, the CPU 26 calculates a display size of the head portion dictionary image HDG. Subsequently, with reference to FIG. 5, the CPU 26 calculates each of a difference in the horizontal position between a region occupied by the marker MK and a partial image EDG indicating the eye and a difference in the vertical position between the same (position of MK−position of EDG), in the head portion dictionary image HDG The CPU 26 also calculates a size of the region occupied by the marker MK.

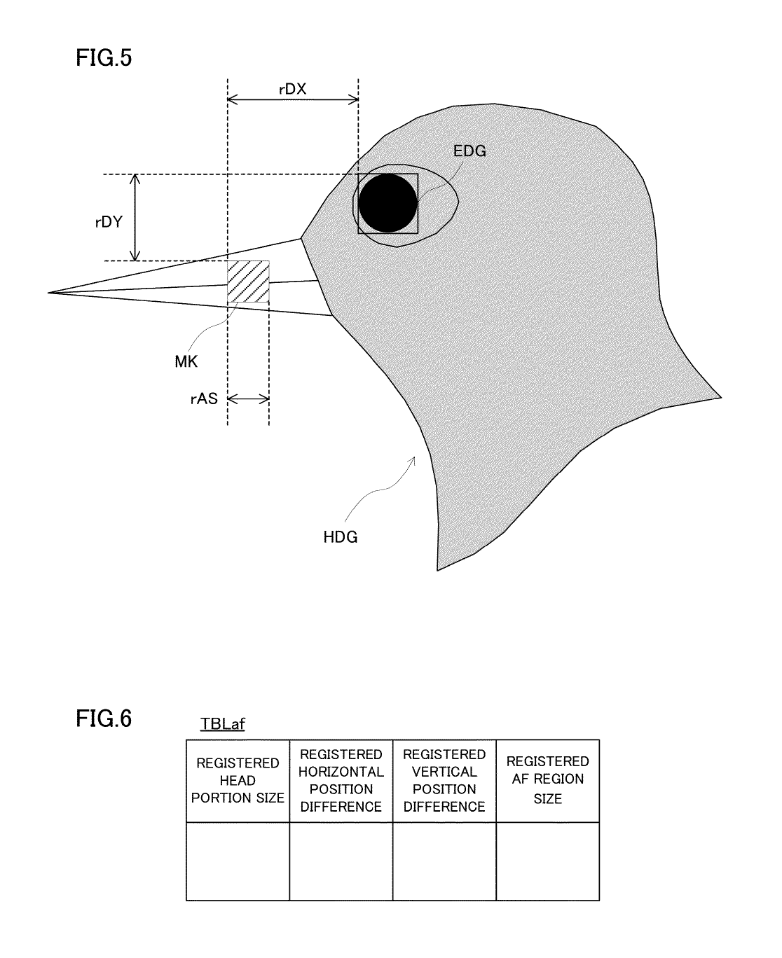

The display size of the head portion dictionary image HDG, the horizontal position difference, the vertical position difference, and the size of the region occupied by the marker MK, which are calculated in this way, are registered in an AF region registration table TBLaf, shown in FIG. 6, as a registered head portion size rHS, a registered horizontal position difference rDX, a registered vertical position difference rDY, and a registered AF region size rAS, respectively. It is noted that the AF region registration table TBLaf is saved in the flash memory 44.

Returning to FIG. 2, the digital camera 10 of the present embodiment includes a focus lens 12 and an aperture unit 14 driven by drivers 18a and 18b, respectively. An optical image of a scene that undergoes theses members enters, with irradiation, an imaging surface of an image sensor 16 driven by a driver 18c, and is subject to a photoelectric conversion.

When the imaging task is activated, in order to execute a moving image taking process, the CPU 26 gives a driver 18c a command to repeat an exposing procedure and a charge reading procedure under the imaging task. The driver 18c exposes the imaging surface of the image sensor 16 and respectively read out charges, which are generated on the imaging surface of the image sensor 16, in a raster scanning manner, in response to a vertical synchronization signal Vsync periodically generated from an SG (Signal Generator) not shown. From the image sensor 16, raw image data based on the read charges is periodically outputted.

A pre-processing circuit 20 performs processes such as digital clamping, pixel defect correction, and gain control, on the raw image data outputted from the image sensor 16. The raw image data on which these processes are performed is written into a raw image area 32a of an SDRAM 32 through a memory control circuit 30.

A post-processing circuit 34 reads out the raw image data accommodated in the raw image area 32a through the memory control circuit 30, and performs a color separating process, a white balance adjusting process, and a YUV converting process on the read-out raw image data. The YUV-formatted image data produced thereby is written into a YUV-formatted image area 32b of the SDRAM 32 through the memory control circuit 30.

Furthermore, the post-processing circuit 34 executes a display-use zoom process and a search-use zoom process on the image data that complies with a YUV format, in a parallel manner. As a result, display image data and search image data that comply with the YUV format are individually created. The display image data is written by the memory control circuit 30 into a display image area 32c of the SDRAM 32. The search image data is written by the memory control circuit 30 into a search image area 32d of the SDRAM 32.

The LCD driver 36 repeatedly reads out the display image data accommodated in the display image area 32c through the memory control circuit 30, and drives the LCD monitor 38 based on the read-out image data. As a result, a real-time moving image (through image) representing a scene is displayed on the LCD monitor 38.

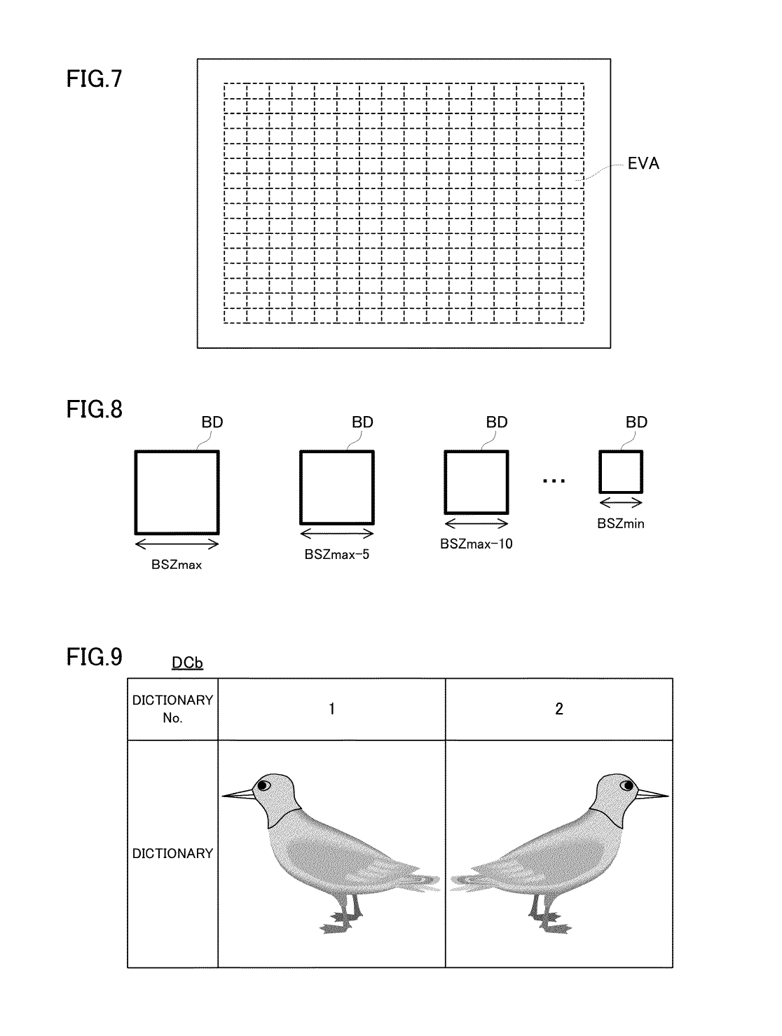

With reference to FIG. 7, an evaluation area EVA is allocated to a center of the imaging surface of the image sensor 16. The evaluation area EVA is divided into 16 portions in each of a horizontal direction and a vertical direction; therefore, 256 divided areas form the evaluation area EVA. Moreover, in addition to the above-described processes, the pre-processing circuit 20 shown in FIG. 2 executes a simple RGB converting process in which the raw image data is simply converted into RGB data.

An AE evaluating circuit 22 integrates RGB data belonging to the evaluation area EVA, out of the RGB data produced by the pre-processing circuit 20, at each generation of the vertical synchronization signal Vsync. Thereby, 256 integral values, that is, 256 AE evaluation values, are outputted from the AE evaluating circuit 22 in response to the vertical synchronization signal Vsync. An AF evaluating circuit 24 integrates a high frequency component of the RGB data belonging to the evaluation area EVA, out of the RGB data generated by the pre-processing circuit 20, at each generation of the vertical synchronization signal Vsync. Thereby, 256 integral values, that is, 256 AF evaluation values, are outputted from the AF evaluating circuit 24 in response to the vertical synchronization signal Vsync. A process based on the AE evaluation value and the AF evaluation value thus obtained is described later.

Furthermore, the CPU 26 gives the driver 18b a command to adjust the aperture amount of the aperture unit 14 to a maximum aperture amount, when the imaging task is activated. As a result, the depth of field is changed to the deepest level. Moreover, the CPU 26 gives a command to the driver 18a to adjust the position of the focus lens 12, and as a result, the focus lens 12 is placed at a default position.

Under a small bird detecting task executed in parallel with the imaging task, the CPU 26 sets a flag FLG_f to an initial value of “0”. Subsequently, in order to search an entire body image of a small bird from the search image data accommodated in the search image area 32d, the CPU 26 executes an entire body detecting process at each generation of the vertical synchronization signal Vsync.

The entire body detecting process uses: an entire body detection frame structure BD of which the size is adjusted as shown in FIG. 8; and an entire body dictionary DCb in which two dictionary images (two images each showing an entire body of a small bird facing right or left) shown in FIG. 9 are contained. It is noted that the entire body dictionary DCb is saved in the flash memory 44.

In the entire body detecting process, firstly, an entire area of the evaluation area EVA is set as a search area. Moreover, in order to define a variable range of the size of the entire body detection frame structure BD, a maximum size BSZmax is set to “200”, and a minimum size BSZmin is set to “20”.

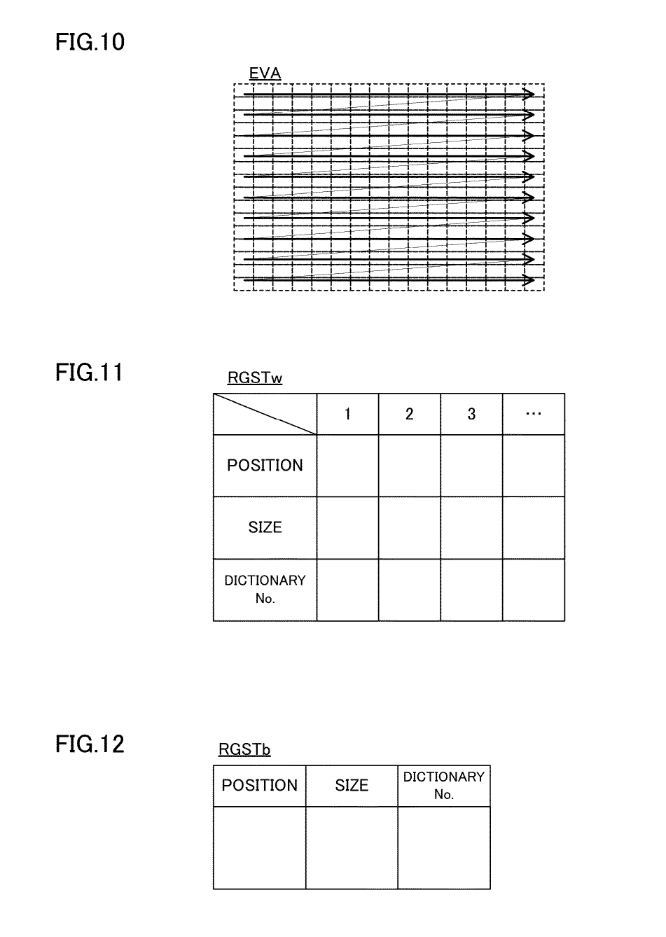

The entire body detection frame structure BD is moved by each predetermined amount from a start position (upper left position) toward an end position (lower right position) in the search area, in a raster scanning manner (see FIG. 10). Moreover, the size of the entire body detection frame structure BD is reduced by each “5” from “BSZmax” to “BSZmin” at each time the entire body detection frame structure BD reaches the end position.

One portion of the search image data belonging to the entire body detection frame structure BD is read out from the search image area 32d through the memory control circuit 30. A characteristic amount of the read-out search image data is checked with a characteristic amount of each of the two dictionary images contained in the entire body dictionary DCb. When a checking degree that exceeds a threshold value TH_B is obtained, it is regarded that the entire body image of the small bird is detected. A position and a size of the entire body detection frame structure BD at a current time point are registered, as small bird entire body information, in an entire body work register RGSTw shown in FIG. 11. Furthermore, a dictionary number of the dictionary image used for detection is also registered in the entire body work register RGSTw.

When single small bird entire body information is registered in the entire body work register RGSTw, upon completion of the search, the CPU 26 duplicates the registered small bird entire body information in the entire body detecting register RGSTb. When a plurality of small bird entire body information are registered in the entire body work register RGSTw, small bird entire body information of which the registered size is largest is duplicated in the entire body detecting register RGSTb. When a plurality of small bird entire body information which indicate the maximum size are registered, the CPU 26 duplicates small bird entire body information of which the registered position is closest to the center of the scene out of these small bird entire body information, in the entire body detecting register RGSTb.

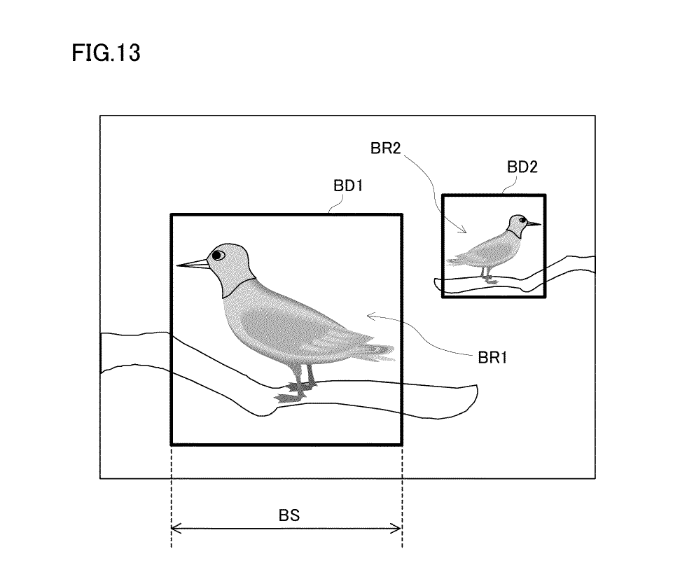

For example, when the entire body detecting process is executed on a search image shown in FIG. 13, small birds BR1 and BR2 are caught by entire body detection frame structures BD1 and BD2, respectively, and a position and a size of each of the entire body detection frame structures BD1 and BD2 are registered in the entire body work register RGSTw. Furthermore, dictionary numbers 1 and 2 corresponding to the small birds BR1 and BR2 are registered in the entire body work register RGSTw. Subsequently, as shown in FIG. 13, the size of the entire body detection frame structure BD1 is larger than the size of the entire body detection frame structure BD2, and thus, the small bird entire body information of the small bird BR1 is duplicated to the entire body detecting register RGSTb.

Upon completion of the entire body detecting process, when the small bird entire body information is registered in the entire body work register RGSTw, the CPU 26 executes the head portion detecting process in order to search for the head portion image of the small bird from the search image data accommodated in the search image area 32d.

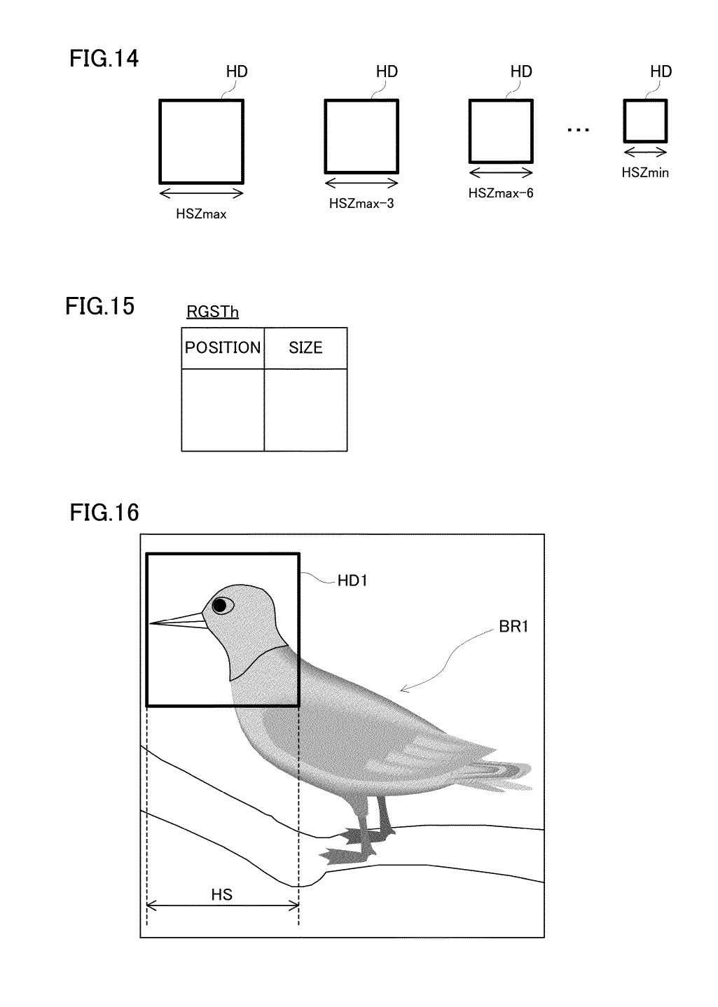

The head portion detecting process uses a head portion detection frame structure HD of which the size is adjusted as shown in FIG. 14 and the head portion dictionary DCh shown in FIG. 3.

In the head portion detecting process, firstly, the region where the small bird is discovered in the entire body detecting process, that is, the region registered in the entire body detecting register RGSTb, is set as a search area. Furthermore, in order to define a variable range of the size of the head portion detection frame structure HD, the maximum size HSZmax is set to a size obtained by multiplying an entire body size BS registered in the entire body detecting register RGSTb by 0.75. Furthermore, the minimum size HSZmin of the head portion detection frame structure HD is set to a size obtained by multiplying the entire body size BS by 0.4.

The head portion detection frame structure HD is moved by each predetermined amount from a start position (upper left position) toward an end position (lower right position) in the search area, in a raster scanning manner. Furthermore, the size of the head portion detection frame structure HD is reduced by each “3” from “HSZmax” to “HSZmin” at each time the head portion detection frame structure HD reaches the end position.

One portion of the search image data belonging to the head portion detection frame structure HD is read out from the search image area 32d through the memory control circuit 30. A characteristic amount of the read-out search image data is checked with a characteristic amount of the dictionary image having the same dictionary number as the dictionary number registered in the entire body detecting register RGSTb, out of the two dictionary images contained in the head portion dictionary DCh, that is, the dictionary image facing the same direction as that of the detected entire body.

When a checking degree that exceeds a threshold value TH_H is obtained, it is regarded that the head portion image of the small bird is detected. A position and a size of the head portion detection frame structure HD at a current time point are registered, as small bird head portion information, in a head portion detecting register RGSTh shown in FIG. 15. When the head portion image is discovered in this way, the head portion detecting process is ended once the registration into the head portion detecting register RGSTh is completed.

For example, when the head portion detecting process is executed on the search image region shown in FIG. 16, the head portion of the small bird BR1 is caught by the head portion detection frame structure HD1, and the position and the size of the head portion detection frame structure HD1 are registered in the head portion detecting register RGSTh.

Upon completion of the head portion detecting process, when the small bird head portion information is registered in the head portion detecting register RGSTh, the CPU 26 executes an eye detecting process in order to search for an eye image of the small bird from the search image data accommodated in the search image area 32d.

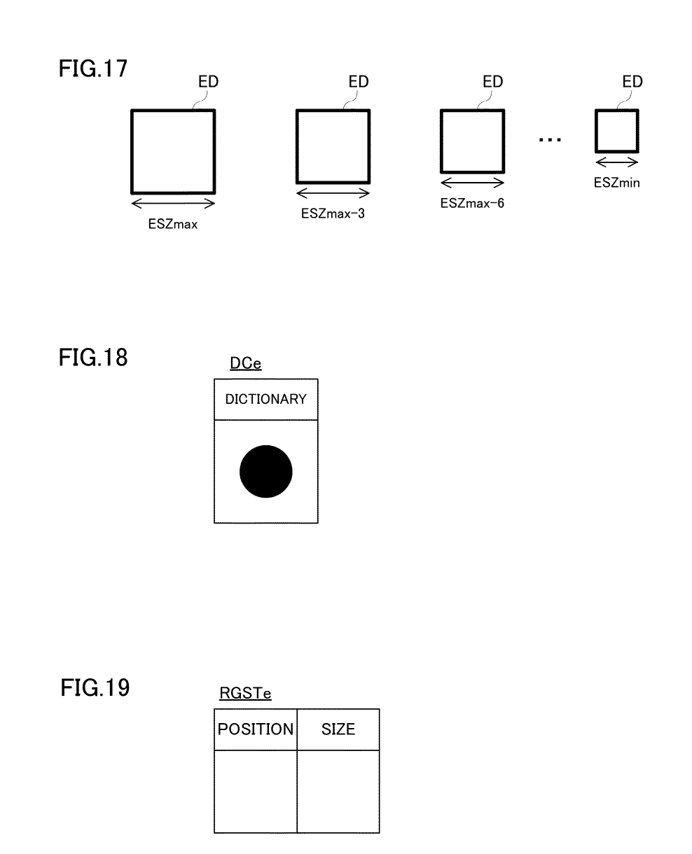

The eye detecting process uses: an eye detection frame structure ED of which the size is adjusted as shown in FIG. 17; and an eye dictionary DCe in which a dictionary image (=image indicating an eye of a small bird) shown in FIG. 18 is contained. It is noted that the eye dictionary DCe is saved in the flash memory 44.

In the eye detecting process, firstly, the region where the head portion of the small bird is discovered in the head portion detecting process, that is, the region registered in the head portion detecting register RGSTh, is set as a search area. Furthermore, in order to define a variable range of the size of the eye detection frame structure ED, a maximum size ESZmax is set to a size obtained by multiplying a head portion size HS registered in the head portion detecting register RGSTh by 0.2. Furthermore, the minimum size ESZmin of the eye detection frame structure ED is set to a size obtained by multiplying the head portion size HS by 0.05.

The eye detection frame structure ED is moved by each predetermined amount from a start position (upper left position) toward an end position (lower right position) in the search area, in a raster scanning manner. Furthermore, the size of the eye detection frame structure ED is reduced by each “3” from “ESZmax” to “ESZmin” at each time the eye detection frame structure ED reaches the end position.

One portion of the search image data belonging to the eye detection frame structure ED is read out from the search image area 32d through the memory control circuit 30. A characteristic amount of the read-out search image data is checked with a characteristic amount of the dictionary image contained in the eye dictionary DCe. When a checking degree that exceeds a threshold value TH_E is obtained, it is regarded that the eye image of the small bird is detected. A position and a size of the eye detection frame structure ED at a current time point are registered, as small bird eye information, in an eye detecting register RGSTe shown in FIG. 19. When the eye image is discovered in this way, the head portion detecting process is ended once the registration into the eye detecting register RGSTe is completed.

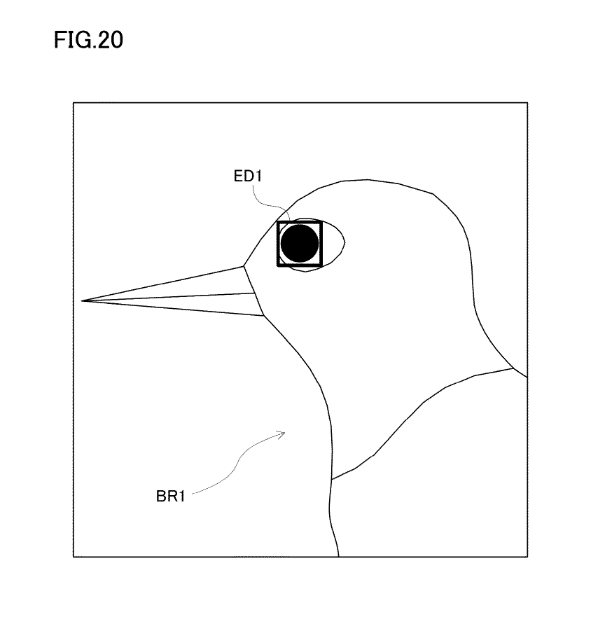

For example, when the eye detecting process is executed on the search image region shown in FIG. 20, the eye of the small bird BR1 is caught by the eye detection frame structure ED1, and the position and the size of the eye detection frame structure ED1 are registered in the eye detecting register RGSTe.

Upon completion of the eye detecting process, when the small bird eye information is registered in the eye detecting register RGSTe, the CPU 26 calculates the region where the AF process is to be performed, in a manner described below. Firstly, a detected eye position EP (Ex, Ey) and a detected head portion size HS are read out from the eye detecting register RGSTe and the head portion detecting register RGSTh, respectively. In continuation, the registered head portion size rHS, the registered horizontal position difference rDX, the registered vertical position difference rDY, and the registered AF region size rAS are read out from the AF region registration table TBLaf.

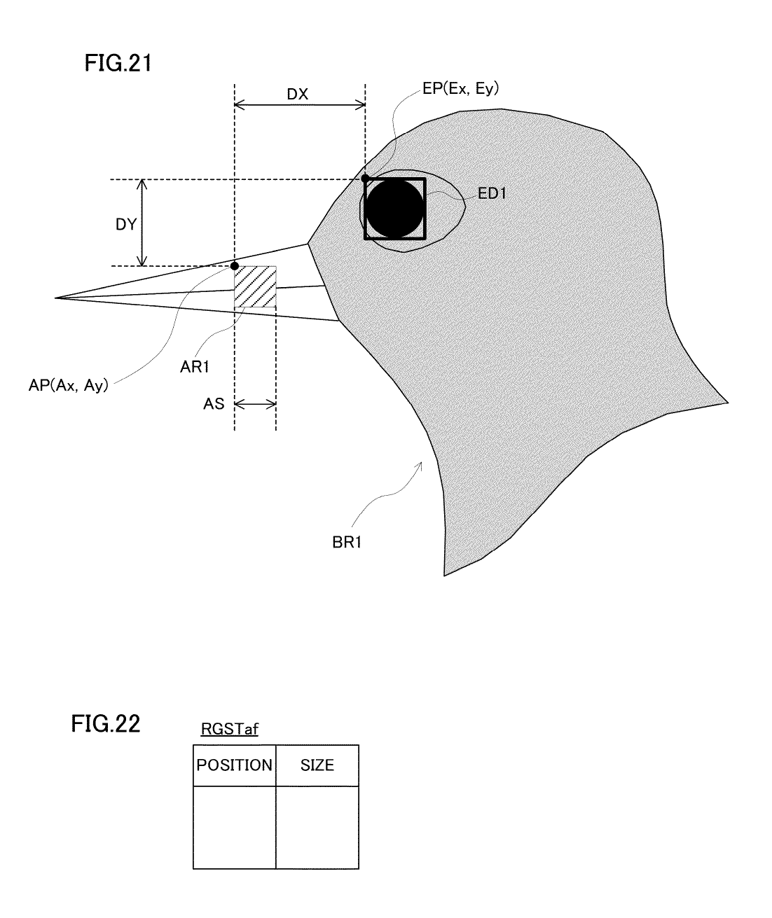

With reference to FIG. 21, based on the detected head portion size HS, the registered head portion size rHS, the registered horizontal position difference rDX, and the registered vertical position difference rDY, which are read out, the CPU 26 calculates a difference DX in the horizontal position between the detected eye position EP and the region where the AF process is to be performed, and a difference DY in the vertical position therebetween.

The difference DX in the horizontal position can be evaluated according to Equation 1 below.

DX=rDX×HS/rHS [Equation 1]

The difference DY in the vertical position can be evaluated according to Equation 2 below.

DY=rDY×HS/rHS [Equation 2]

Based on thus calculated differences DX and DY and the detected eye position EP (Ex, Ey), the CPU 26 calculates a position AP (Ax, Ay) of the region where the AF process is to be performed.

The horizontal position Ax of the region where the AF process is to be performed can be evaluated according to Equation 3 below.

Ax=Ex+DX [Equation 3]

The vertical position Ay of the region where the AF process is to be performed can be evaluated according to Equation 4 below.

Ay=Ey+DY [Equation 4]

Subsequently, the CPU 26 calculates a size AS of the region where the AF process is to be performed, based on the detected head portion size HS, the registered head portion size rHS, and the registered AF region size rAS, which are read out. The size AS of the region where the AF process is to be performed can be evaluated according to Equation 5 below.

AS=rAS×HS/rHS [Equation 5]

The position AP (Ax, Ay) and the size AS of the region where the AF process is to be performed, which are calculated in this way, are registered in a small bird AF region register RGSTaf shown in FIG. 22. Furthermore, the CPU 26 sets the flag FLG_f to “1” in order to declare that the eye of the small bird is discovered and that the region where the AF process is to be performed is set.

When a shutter button 28sh is in a non-operation state, the CPU 26 executes a process described below. When the flag FLG_f indicates “0”, the CPU 26 executes a simple AE process based on the output from the AE evaluating circuit 22, under the imaging task, so as to calculate an appropriate EV value. The simple AE process is executed in parallel with the moving image taking process, and sets an aperture amount and an exposure time defining the calculated appropriate EV value, to the drivers 18b and 18c, respectively. As a result, the brightness of the live view image is adjusted moderately.

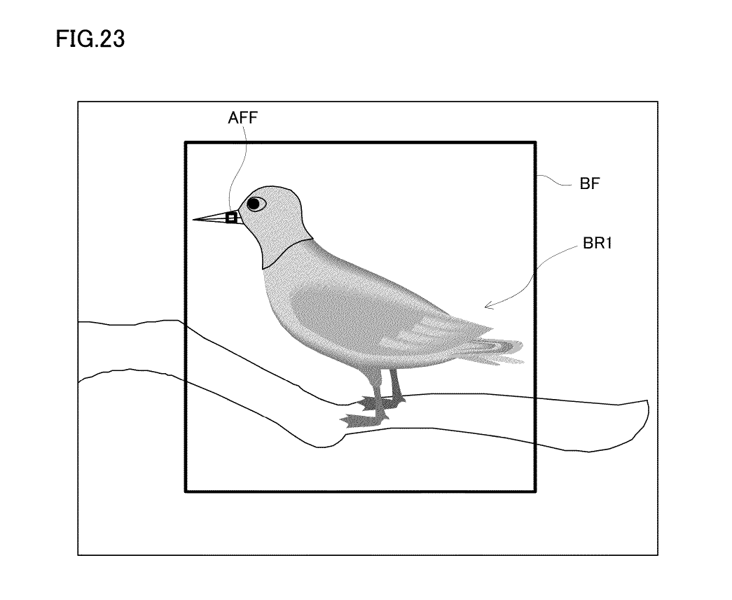

When the flag FLG_f is updated to “1”, the CPU 26 requests a graphic generator 46 to display a small bird entire body frame structure BF, with reference to a registered content of the entire body detecting register RGSTb. The graphic generator 46 outputs graphic information representing the small bird entire body frame structure BF toward the LCD driver 36. As a result, with reference to FIG. 23, the small bird entire body frame structure BF is displayed on the LCD monitor 38 in a manner to adapt to the position and the size of the entire body of the small bird on the live view image.

Furthermore, when flag FLG_f is updated to “1”, the CPU 26 extracts AE evaluation values corresponding to the position and the size registered in the entire body detecting register RGSTb, out of the 256 AE evaluation values outputted from the AE evaluating circuit 22. The CPU 26 executes a strict AE process that is based on the extracted AE evaluation values. An aperture amount and an exposure time defining an optimal EV value calculated by the strict AE process are set to the drivers 18b and 18c, respectively. As a result, a brightness of the live view image is adjusted to a brightness in which the entire body of the small bird is noticed.

When the shutter button 28sh is half depressed, the CPU 26 executes the AF process. When the flag FLG_f indicates “0”, the CPU 26 gives the driver 18b a command to adjust the aperture amount of the aperture unit 14 to an intermediate level. As a result, the depth of field is changed to the intermediate level. When the depth of field is changed, the CPU 26 extracts AF evaluation values corresponding to a predetermined region at a center of a scene, out of the 256 AF evaluation values outputted from the AF evaluating circuit 24. Based on the AF evaluation values thus extracted, the CPU 26 executes the AF process. As a result, the focus lens 12 is placed at a focal point in which the center of the scene is noticed, and this serves to improve a sharpness of the live view image.

When the flag FLG_f indicates “1”, the CPU 26 gives the driver 18b a command to adjust the aperture amount of the aperture unit 14 to a minimum aperture amount. As a result, the depth of field is changed to the shallowest level. When the depth of field is changed, the CPU 26 extracts AF evaluation values corresponding to the position and the size registered in the small bird AF region register RGSTaf, out of the 256 AF evaluation values outputted from the AF evaluating circuit 24. Based on the AF evaluation values thus extracted, the CPU 26 executes the AF process. As a result, the focus lens 12 is placed at a focal point in which a region equivalent to the region registered in the region registering task is noticed, and this serves to improve a sharpness of the region in the live view image.

Upon completion of the AF process, the CPU 26 requests the graphic generator 46 to display a focus frame structure AFF in the region where the AF process is to be performed. The graphic generator 46 outputs the graphic information representing the focus frame structure AFF, toward the LCD driver 36. As a result, when the flag FLG_f indicates “1”, the focus frame structure AFF is displayed on the LCD monitor 38 in a manner to adapt to the position and the size registered in the small bird AF region register RGSTaf (see FIG. 23).

When the shutter button 28sh is fully depressed, the CPU 26 executes the still image taking process and the recording process, under the imaging task. One frame of the raw image data obtained at a time point at which the shutter button 28sh is fully depressed is taken, by the still image taking process, into a still image area 32e of the SDRAM 32. Furthermore, one still image file is created, by the recording process, on a recording medium 42. The taken raw image data is recorded, by the recording process, into a newly created still image file.

It is noted that when a setting of the automatic shutter is set to ON, the depth of field is changed to the shallowest level, in continuation to the above-described strict AE process, and the AF process in which the region registered in the small bird AF region register RGSTaf is noticed is executed. Furthermore, upon completion of the AF process, the above-described still image fetching process and recording process are executed.

When the reproducing task is activated, under the reproducing task, the CPU 26 designates a latest still image file recorded, on the recording medium 42, and executes a reproducing process in which the designated still image file is noticed. As a result, an optical image corresponding to the image data of the designated still image file is displayed on the LCD monitor 38.

By the operation of the key input device 28 by the operator, the CPU 26 designates a succeeding still image file or a preceding still image file. The designated still image file is subjected to a reproducing process similar to that described above, and as a result, the display on the LCD monitor 38 is updated.

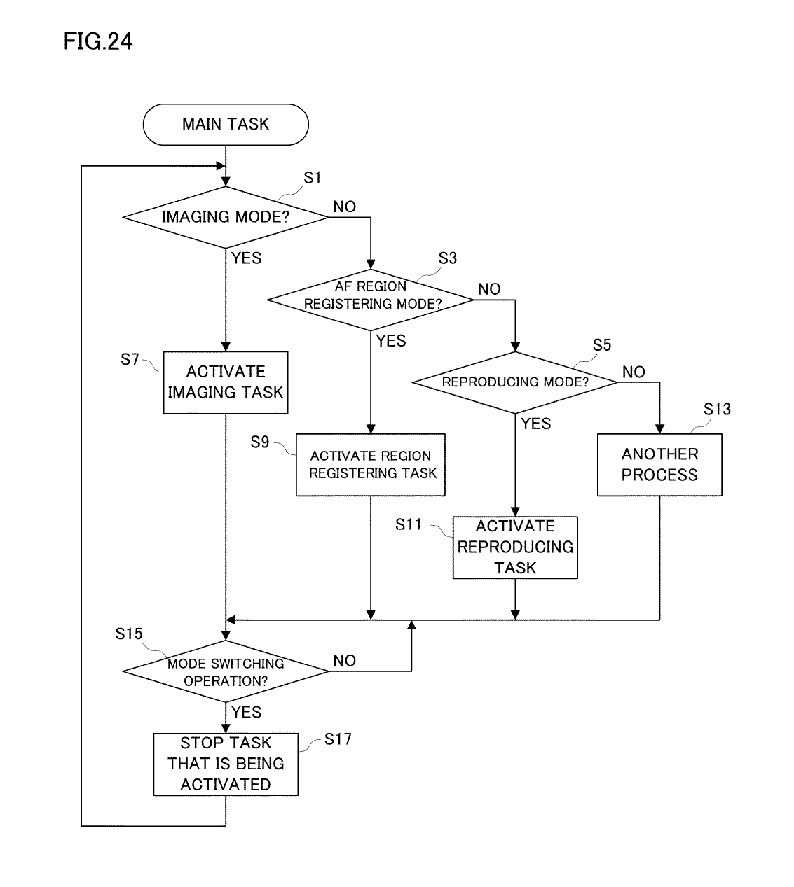

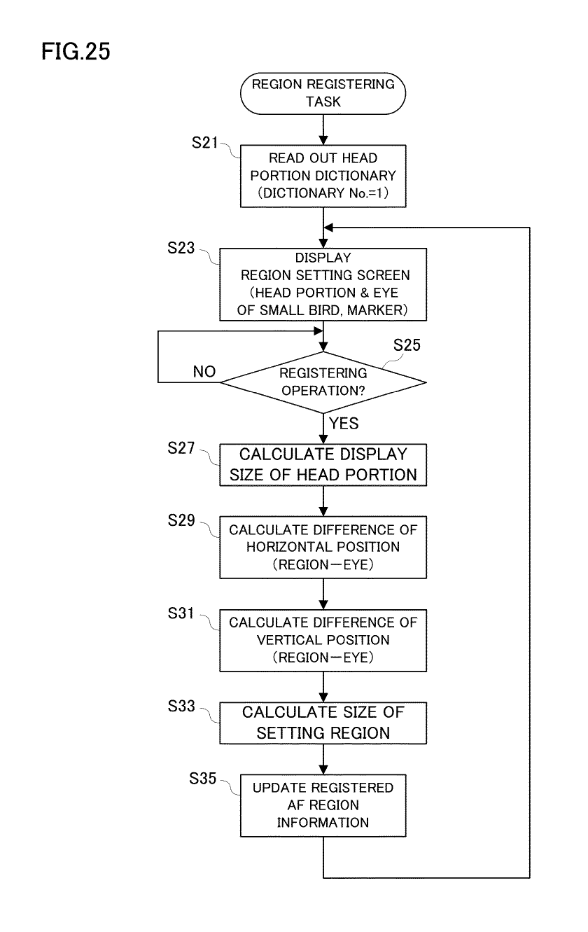

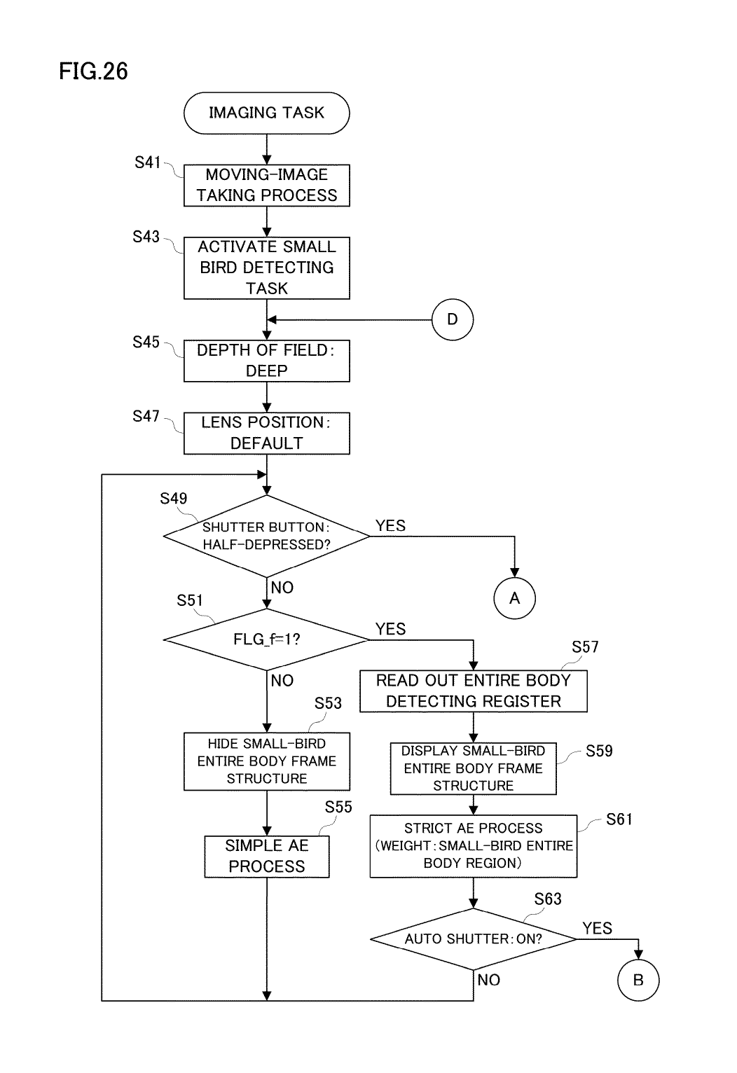

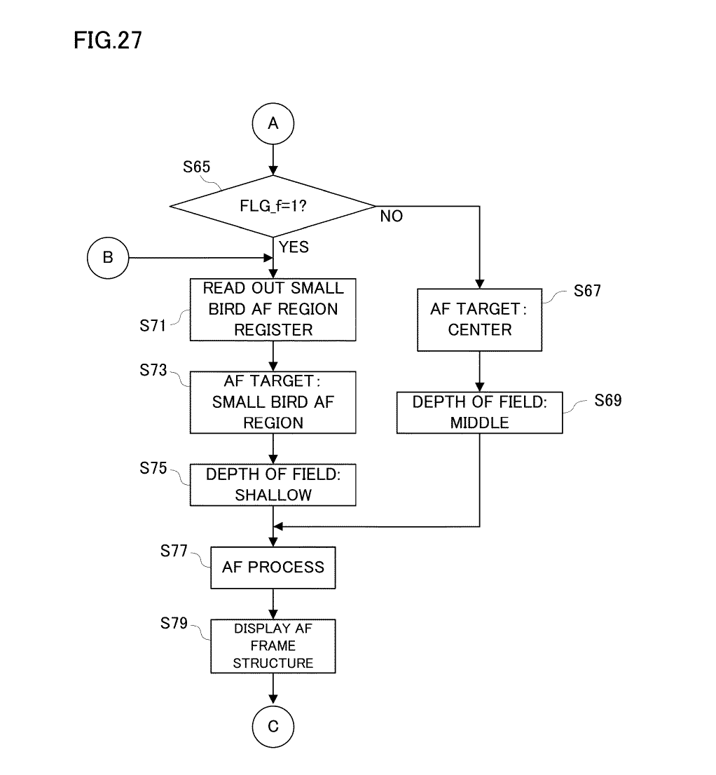

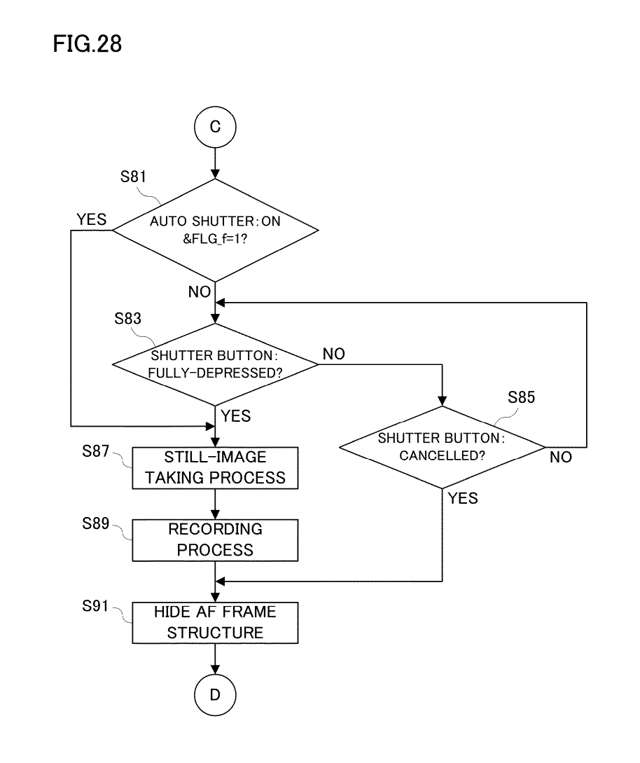

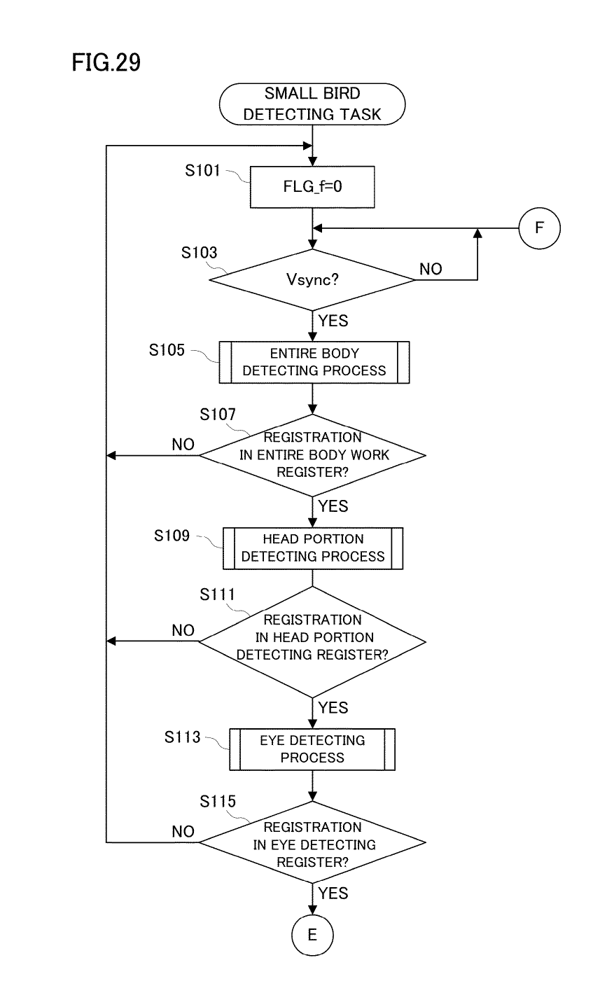

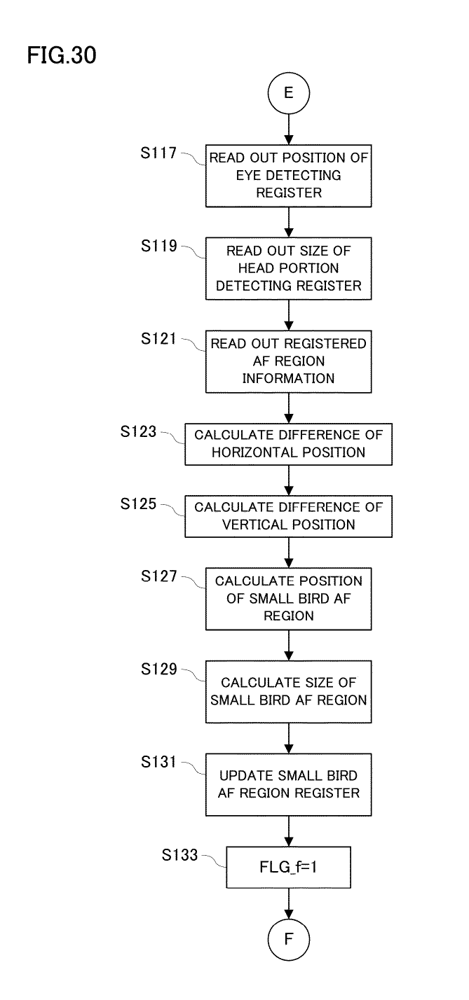

The CPU 26 executes, in a parallel manner, a plurality of tasks including a main task shown in FIG. 24, a region registering task shown in FIG. 25, an imaging task shown in FIG. 26 to FIG. 28, and a small bird detecting task shown in FIG. 29 to FIG. 30. It is noted that a control program corresponding to these tasks is stored in the flash memory 44.

With reference to FIG. 24, it is determined in a step S1 whether or not an operation mode at a current time point is the imaging mode, it is determined in a step S3 whether or not the operation mode at a current time point is the AF region registering mode, and it is determined in a step S5 whether or not the operation mode at a current time point is the reproducing mode. When YES is determined in the step S1, the imaging task is activated in a step S7, when YES is determined in the step S3, the region registering task is activated in a step S9, and when YES is determined in the step S5, the reproducing task is activated in a step S11. When NO is determined in all of the steps S1 to S5, another process is executed in a step S13. Upon completion of the process in any one of the steps S7 to S13, it is repeatedly determined in a step S15 whether or not a mode switching operation is performed. When a determined result is updated from NO to YES, the task during activation is stopped in a step S17, and then, the process returns to the step S1.

With reference to FIG. 25, in a step S21, the dictionary image data having the dictionary number 1 of the head portion dictionary DCh is read out, and based on the read-out dictionary image data, the region setting screen is displayed on the LCD monitor 38 in a step S23.

In a step S25, it is repeatedly determined whether or not the registering operation of the region where the AF process is to be performed is performed, and when a determined result is updated from NO to YES, the display size of the head portion dictionary image HDG is calculated in a step S27.

In a step S29, the difference in the horizontal position between the region occupied by the marker MK and the partial image EDG indicating the eye in the head portion dictionary image HDG is calculated, and the difference in the vertical position is calculated in a step S31. In a step S33, the size of a setting region occupied by the marker MK is calculated.

The display size of the head portion dictionary image HDC; the difference in the horizontal position, the difference in the vertical position, and the size of the region occupied by the marker MK, which are thus calculated, are registered in the AF region registration table TBLaf, in a step S35, as the registered head portion size rHS, the registered horizontal position difference rDX, the registered vertical position difference rDY, and the registered AF region size rAS, respectively. Upon completion of the process in the step S35, the process returns to the step S23.

With reference to FIG. 26, the moving image taking process is executed in a step S41. As a result, a live view image representing a scene is displayed on the LCD monitor 38. In a step S43, the small bird detecting task is activated.

In a step S45, the driver 18b is given a command to adjust the aperture amount of the aperture unit 14 to the maximum aperture amount. As a result, the depth of field is changed to the deepest level. In a step S47, the driver 18a is given a command to adjust the position of the focus lens 12, and as a result, the focus lens 12 is placed at the default position.

In a step S49, it is determined whether or not the shutter button 28sh is half depressed, and when a determined result is YES, the process proceeds to a step S65 while when the determined result is NO, whether or not the flag FLG_f is set to “1” is determined in a step S51.

When a determined result of the step S51 is NO, the graphic generator 46 is requested for a non-display of the small bird entire body frame structure BF in a step S53. As a result, the small bird entire body frame structure BF displayed on the LCD monitor 38 is non-displayed.

Upon completion of the process in the step S53, the simple AE process is executed in a step S55. The aperture amount and the exposure time defining the appropriate EV value calculated by the simple AE process are set to the drivers 18b and 18c, respectively. As a result, the brightness of the live view image is adjusted moderately. Upon completion of the process of the step S55, the process returns to the step S49.

When a determined result of the step S51 is YES, the position and the size registered in the entire body detecting register RGSTb are read out in a step S57. Based on the read-out position and size, the graphic generator 46 is requested to display the small bird entire body frame structure BF in a step S59. As a result, the small bird entire body frame structure BF is displayed on the LCD monitor 38 in a manner to adapt to the position and the size of the entire body image of the small bird detected under the small bird detecting task.

Upon completion of the process in the step S59, the strict AE process corresponding to the position of the entire body image of the small bird is executed in a step S61. An aperture amount and an exposure time defining an optimal EV value calculated by the strict AE process are set to the drivers 18b and 18c, respectively. As a result, the brightness of the live view image is adjusted to the brightness in which one portion of the scene equivalent to the entire body of the small bird is noticed.

In a step S63, it is determined whether or not the setting of the automatic shutter is turned ON, and when a determined result is YES, the process proceeds to a step S71 while when the determined result is NO, the process returns to the step S49.

In a step S65, it is determined whether or not the flag FLG_f is set to “1”, and when a determined result is NO, the process proceeds to a step S77 after undergoing steps S67 and S69 while when the determined result is YES, the process proceeds to the step S77 after undergoing steps S71 to S75.

In the step S67, it is set that the AF process is to be performed at the center of the scene. In the step S69, the driver 18b is given a command to adjust the aperture amount of the aperture unit 14 to an intermediate level. As a result, the depth of field is changed to the intermediate level.

In the step S71, in order to finalize the region where the AF process is to be performed, the position and the size registered in the small bird AF region register RGSTaf are read out. The read-out small bird AF region is set to be the region where the AF process is to be performed in the step S73. In the step S75, the driver 18b is given a command to adjust the aperture amount of the aperture unit 14 to the minimum aperture amount. As a result, the depth of field is changed to the shallowest level.

In the step S77, the AF process in which the subject region set in the step S67 or the step S73 is noticed, is executed. As a result, the focus lens 12 is placed at the focal point in which the region is noticed, and this serves to improve the sharpness of the region in the live view image.

In a step S79, the graphic generator 46 is requested to display the focus frame structure AFF into the region where the AF process is to be performed. As a result, the focus frame structure AFF is displayed on the LCD monitor 38 in a manner to adapt to the region.

In a step S81, it is determined whether or not the setting of the automatic shutter is turned ON and the flag FLG_f is set to “1”. When a determined result is NO, the process proceeds to a step S83, and when the determined result is YES, the process proceeds to a step S87.

In the step S83, it is determined whether or not the shutter button 28sh is fully depressed, and when a determined result is NO, it is determined in a step S85 whether or not the shutter button 28sh is released. When a determined result of the step S85 is NO, the process returns to the step S83 while when the determined result of the step S85 is YES, the process proceeds to a step S91.

When the determined result of the step S83 is YES, the still image taking process is executed in the step S87, and the recording process is executed in a step S89. One frame of the image data obtained at a time point at which the shutter button 28sh is fully depressed is taken, by the still image taking process, into the still image area 32e. One frame of the taken image data is read out, by the I/F 40 activated in association with the recording process, from the still image area 32e, and is recorded on the recording medium 42 in a file format.

In the step S91, the graphic generator 46 is requested for a non-display of the focus frame structure AFF. As a result, the focus frame structure AFF displayed on the monitor 38 is non-displayed. Upon completion of the process of the step S91, the process returns to the step S45.

With reference to FIG. 29, in a step S101, the flag FLG_f is set to an initial value of “0”, and it is repeatedly determined in a step S103 whether or not the vertical synchronization signal Vsync is generated. When a determined result is updated from NO to YES, the entire body detecting process is executed in a step S105.

Upon completion of the entire body detecting process, it is determined in a step S107 whether or not there is the small bird entire body information registered in the entire body work register RGSTw, and when a determined result is NO, the process returns to the step S101 while when the determined result is YES, the process proceeds to a step S109.

In the step S109, the head portion detecting process is executed. Upon completion of the head portion detecting process, it is determined in a step S111 whether or not there is the small bird head portion information registered in the head portion detecting register RGSTh, and when a determined result is NO, the process returns to the step S101 while when the determined result is YES, the process proceeds to a step S113.

In the step S113, the eye detecting process is executed. Upon completion of the eye detecting process, it is determined in a step S115 whether or not there is the small bird eye information registered in the eye detecting register RGSTe, and when a determined result is NO, the process returns to the step S101 while when the determined result is YES, the process proceeds to a step S117.

In the step S117, the detected eye position EP (Ex, Ey) is read out from the eye detecting register RGSTe, and in a step S119, the detected head portion size HS is read out from the head portion detecting register RGSTh. In a step S121, the registered head portion size rHS, the registered horizontal position difference rDX, the registered vertical position difference rDY, and the registered AF region size rAS are read out from the AF region registration table TBLaf.

Based on the detected head portion size HS, the registered head portion size rHS, the registered horizontal position difference rDX, and the registered vertical position difference rDY, which are read out, the difference DX in the horizontal position between the detected eye position EP and the region where the AF process is to be performed is calculated in a step S123, and the difference DY in the vertical position is calculated in a step S125.

Based on thus calculated difference DX in the horizontal position and difference DY in the vertical position, and the detected eye position EP (Ex, Ey), the position AP (Ax, Ay) of the region where the AF process is to be performed is calculated in a step S127.

Subsequently, based on the detected head portion size HS, the registered head portion size rHS, and the registered AF region size rAS, which are read out, the size AS of the region where the AF process is to be performed is calculated in a step S129.

In a step S131, the position AP (Ax, Ay) of the region where the AF process is to be performed, which is calculated in the step S127, and the size AS calculated in the step S129 are registered in the small bird AF region register RGSTaf. In a step S133, in order to declare that the eye of the small bird is discovered and that the region where the AF process is to be performed is set, the flag FLG_f is set to “1”. Upon completion of the process in the step S133, the process returns to the step S103.

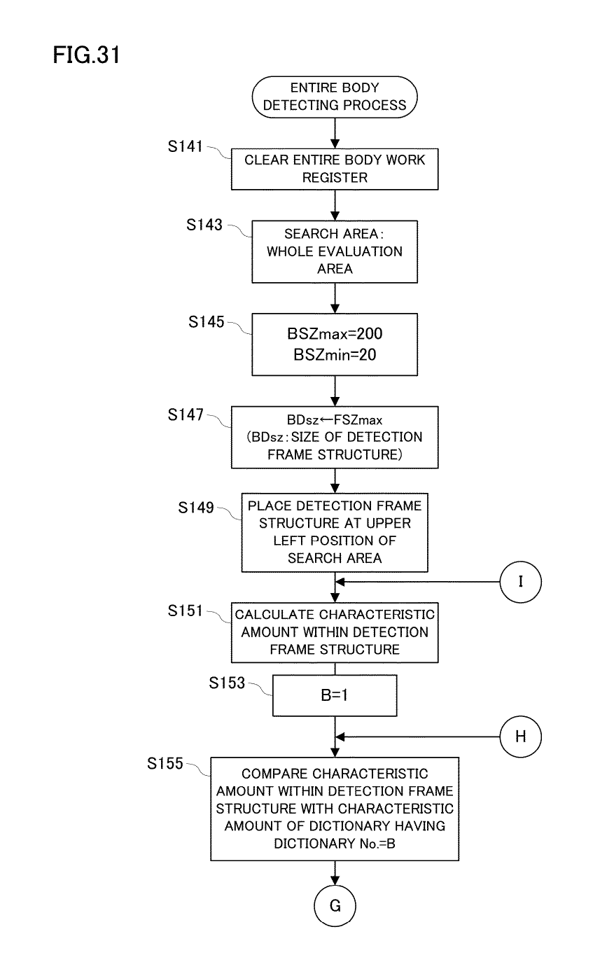

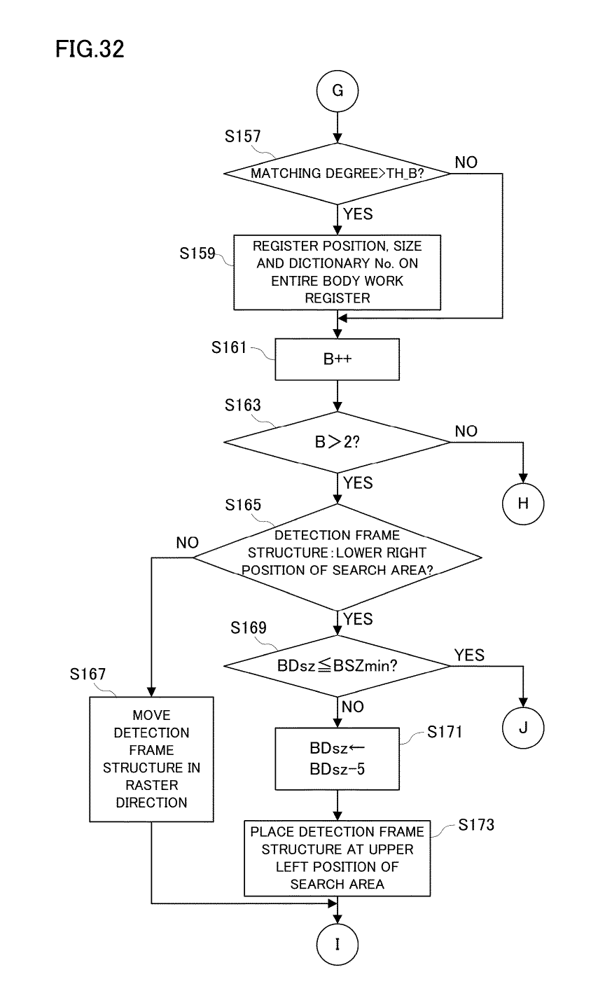

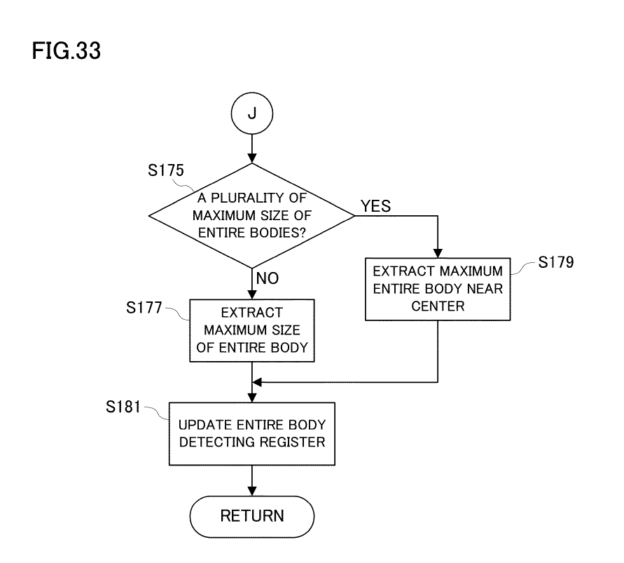

The entire body detecting process in the step S105 is executed according to a subroutine shown in FIG. 31 to FIG. 33. In a step S141, the registered content is cleared in order to initialize the entire body work register RGSTw.

In a step S143, the entire area of the evaluation area EVA is set as a search area. In a step S145, in order to define a variable range of the size of the entire body detection frame structure BD, the maximum size BSZmax is set to “200”, and the minimum size BSZmin is set to “20”.

In a step S147, the size of the entire body detection frame structure BD is set to “BSZmax”, and in a step S149, the entire body detection frame structure BD is placed at the upper left position in the search area. In a step S151, one portion of the search image data belonging to the entire body detection frame structure BD is read out from the search image area 32d, and the feature amount of the read-out search image data is calculated.

In a step S153, a variable B is set to “1”, and in a step S155, the characteristic amount calculated in the step S151 is checked with the characteristic amount of the dictionary image of the entire body dictionary DCb having a dictionary number B. In a step S157, it is determined as a result of checking whether or not the checking degree that exceeds the threshold value TH_B is obtained, and when a determined result is NO, the process proceeds to a step S161 while when the determined result is YES, the process proceeds to the step S161 via a process in a step S159.

In the step S159, the position and the size of the entire body detection frame structure BD at a current time point are registered, as the small bird entire body information, into the entire body work register RGSTw.

In the step S161, the variable B is incremented, and in a step S163, it is determined whether or not the variable B exceeds “2”. When a determined result is NO, the process returns to the step S155 while when the determined result is YES, it is determined in a step S165 whether or not the entire body detection frame structure BD reaches the lower right position in the search area.

When a determined result of the step S165 is NO, the entire body detection frame structure BD is moved in a step S167, by a predetermined amount, in a raster direction, and then, the process returns to the step S151. When the determined result of the step S165 is YES, it is determined in a step S169 whether or not the size of the entire body detection frame structure BD is equal to or less than “BSZmin”. When a determined result of the step S169 is NO, the size of the entire body detection frame structure BD is reduced by “5” in a step S171, the entire body detection frame structure BD is placed at the upper left position in the search area in a step S173, and then, the process returns to the step S151. When the determined result of the step S169 is YES, the process proceeds to a step S175.

In the step S175, it is determined whether or not there are a plurality of the small bird entire body information registered in the entire body work register RGSTw, and when a determined result is NO, the process proceeds to a step S181 after undergoing a step S177 while when the determined result is YES, the process proceeds to the step S181 after undergoing a step S179.

In the step S177, small bird entire body information of which the size is the maximum, out of the small bird entire body information registered in the entire body work register RGSTw, is extracted. In the step S179, small bird entire body information located closest to the center, out of the maximum-sized small bird entire body information registered in the entire body work register RGSTw, is extracted.

In the step S181, the small bird entire body information extracted in the step S177 or S179 is used so as to update the entire body detecting register RGSTb. Upon completion of the process in the step S181, the process is returned to the routine at a hierarchical upper level.

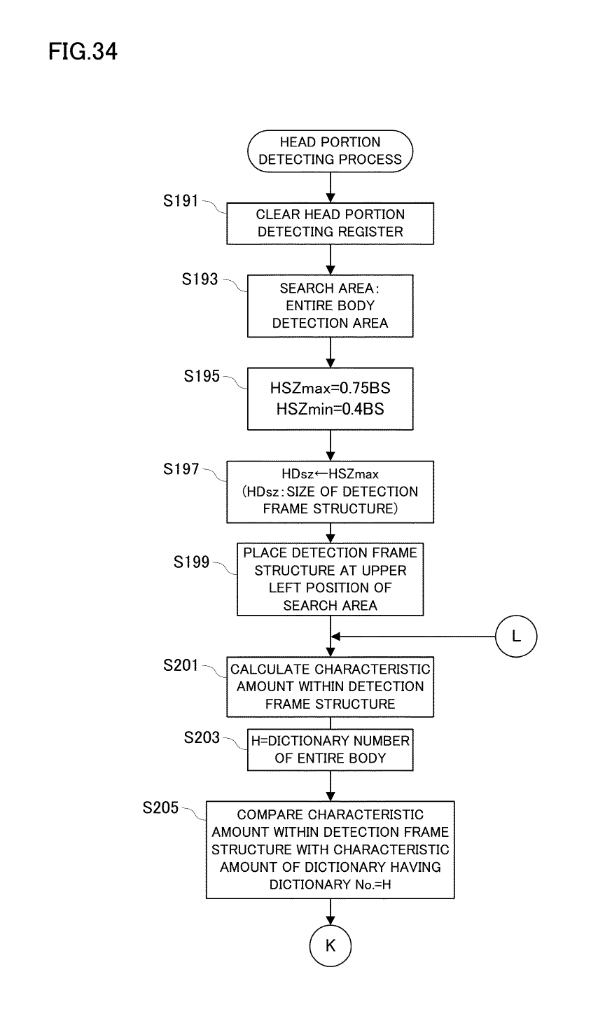

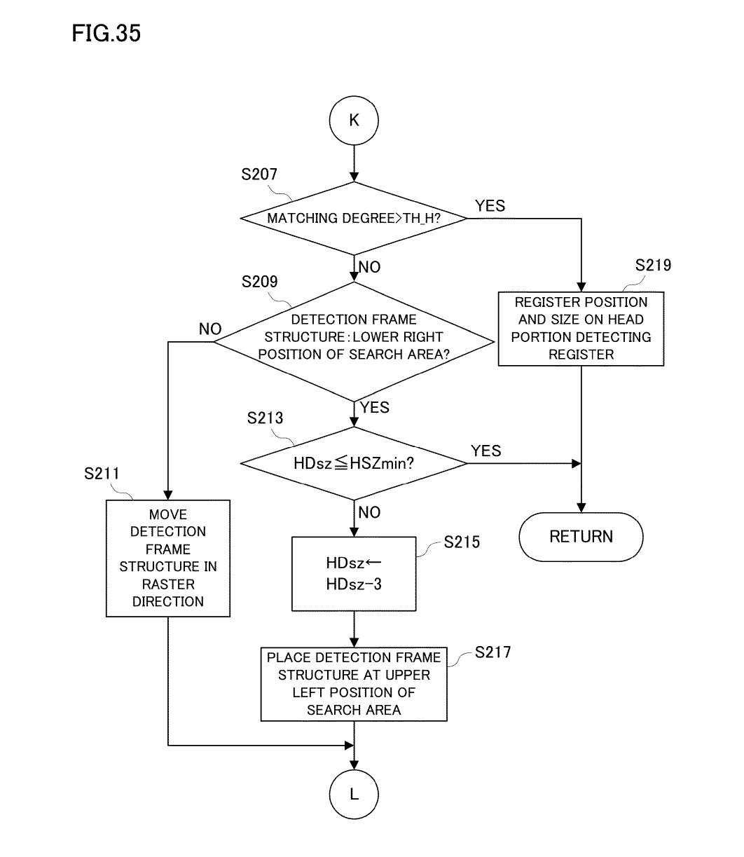

The head portion detecting process in the step S109 is executed according to a subroutine shown in FIG. 34 and FIG. 35. In a step S191, the registered content is cleared in order to initialize the head portion detecting register RGSTh.

In a step S193, the region registered in the entire body detecting register RGSTb is set as a search area. In a step S195, in order to define a variable range of the size of the head portion detection frame structure HD, the maximum size HSZmax is set to a size obtained by multiplying the entire body size BS registered in the entire body detecting register RGSTb by 0.75, and the minimum size HSZmin is set to a size obtained by multiplying the entire body size BS by 0.4.

In a step S197, the size of the head portion detection frame structure HD is set to “HSZmax”, and in a step S199, the head portion detection frame structure HD is placed at the upper left position in the search area. In a step S201, one portion of the search image data belonging to the head portion detection frame structure HD is read out from the search image area 32d, and the characteristic amount of the read-out search image data is calculated.

In a step S203, the variable H is set to the dictionary number registered in the entire body detecting register RGSTb, and the characteristic amount calculated in the step S201 is checked with the characteristic amount of the dictionary image of the head portion dictionary DCh having a dictionary number H in a step S205. In a step S207, it is determined whether or not the checking degree that exceeds the threshold value TH_H is obtained as a result of checking, and when a determined result is NO, the process proceeds to a step S209 while when the determined result is YES, the process proceeds to a step S219.

In the step S209, it is determined whether or not the head portion detection frame structure HD reaches the lower right position in the search area. When a determined result is NO, the head portion detection frame structure HD is moved in a step S211, by a predetermined amount, in the raster direction, and then, the process returns to the step S201. When the determined result is YES, it is determined in a step S213 whether or not the size of the head portion detection frame structure HD is equal to or less than “HSZmin”. When a determined result of the step S213 is NO, the size of the head portion detection frame structure HD is reduced by “3” in a step S215, the head portion detection frame structure HD is placed at the upper left position in the search area in a step S217, and then, the process returns to the step S201. When the determined result of the step S213 is YES, the process is returned to the routine at a hierarchical upper level.

In the step S219, the position and the size of the head portion detection frame structure HD at a current time point are registered, as the small bird head portion information, into the head portion detecting register RGSTh. Upon completion of the process of the step S219, the process is returned to the routine at a hierarchical upper level.

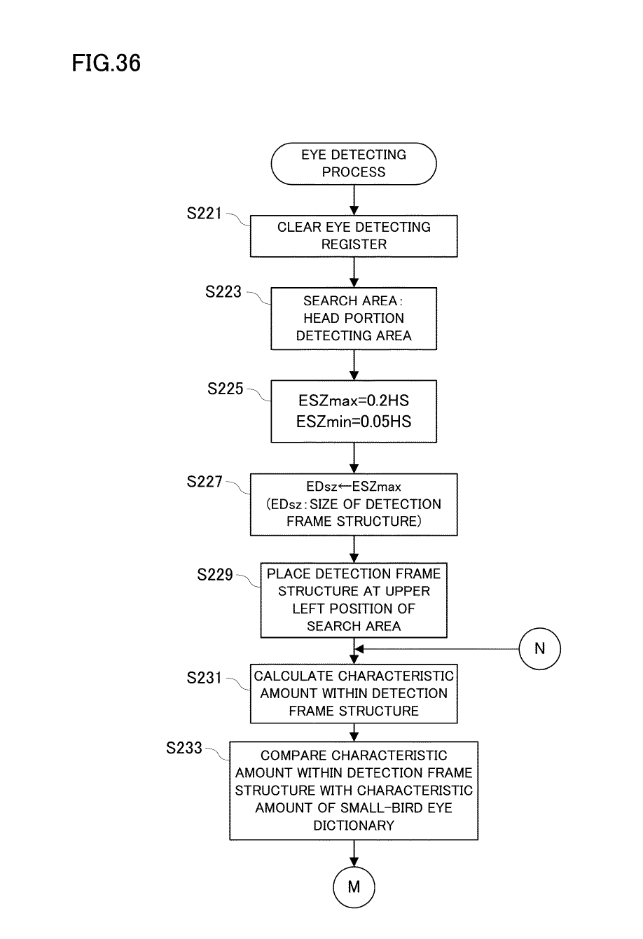

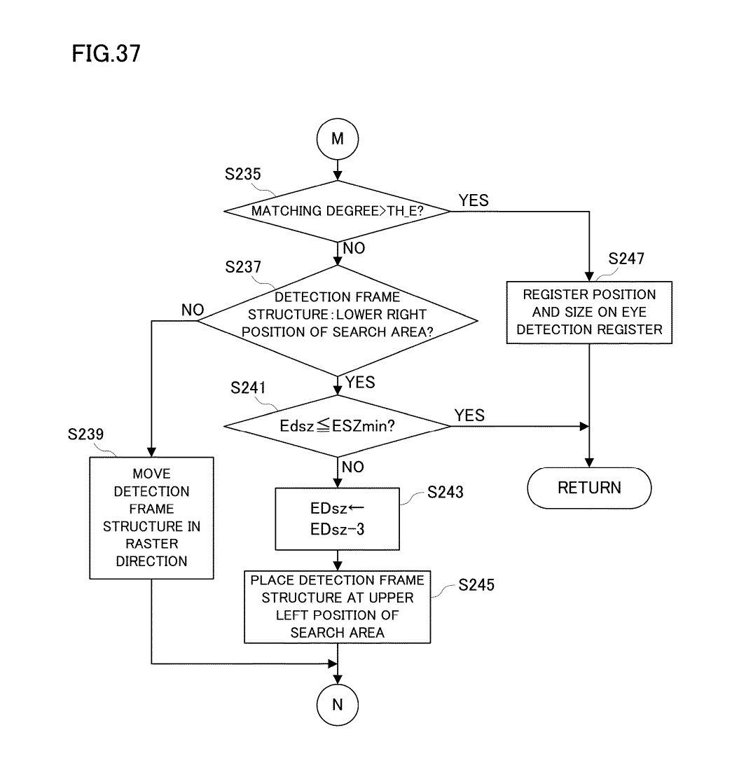

The eye detecting process in the step S113 is executed according to a subroutine shown in FIG. 36 and FIG. 37. In a step S221, the registered content is cleared in order to initialize the eye detecting register RGSTe.

In a step S223, the region registered in the head portion detecting register RGSTh is set as a search area. In a step S225, in order to define a variable range of the size of the eye detection frame structure ED, the maximum size ESZmax is set to a size obtained by multiplying the head portion size HS registered in the head portion detecting register RGSTh by 0.2, and the minimum size ESZmin is set to a size obtained by multiplying the head portion size HS by 0.05.

In a step S227, the size of the eye detection frame structure ED is set to “ESZmax”, and in a step S229, the eye detection frame structure ED is placed at the upper left position in the search area. In a step S231, one portion of the search image data belonging to the eye detection frame structure ED is read out from the search image area 32d, and the characteristic amount of the read-out search image data is calculated.

In a step S233, the characteristic amount calculated in the step S231 is checked with the characteristic amount of the dictionary image of the eye dictionary DCe. In a step S235, it is determined whether or not the checking degree that exceeds the threshold value TH_E is obtained as a result of checking, and when a determined result is NO, the process proceeds to a step S237 while when the determined result is YES, the process proceeds to a step S247.

In the step S237, it is determined whether or not the eye detection frame structure ED reaches the lower right position in the search area. When a determined result is NO, the eye detection frame structure ED is moved in a step S239, by a predetermined amount, in the raster direction, and then, the process returns to the step S231. When the determined result is YES, it is determined in a step S241 whether or not the size of the eye detection frame structure ED is equal to or less than “ESZmin”. When a determined result of the step S241 is NO, the size of the eye detection frame structure ED is reduced by “3” in a step S243, the eye detection frame structure ED is placed at the upper left position in the search area in a step S245, and then, the process returns to the step S231. When the determined result of the step S241 is YES, the process is returned to the routine at a hierarchical upper level.

In the step S247, the position and the size of the eye detection frame structure ED at a current time point are registered, as the small bird eye information, into the eye detecting register RGSTe. Upon completion of the process of the step S247, the process is returned to the routine at a hierarchical upper level.

As understood from the above description, the image sensor 16 repeatedly outputs the image representing the scene. The CPU 26 registers the relative position information in response to the registering operation, and searches for the predetermined site image representing the predetermined site forming the specific object, from the image outputted from the image sensor 16. Furthermore, the CPU 26 detects the reference position on the specific object image appearing in the image outputted from the image sensor 16, based on the searched-out predetermined site image and the registered relative position information. The CPU 26 adjusts the imaging condition based on the partial image present at the detected reference position, out of the image outputted from the image sensor 16.

The relative position information is registered in response to the registering operation. Furthermore, the predetermined site image is searched from the image outputted from the image sensor 16. Based on the searched-out predetermined site image and the registered relative position information, the reference position on the specific object image appearing on the image outputted from the image sensor 16 is detected. Based on the partial image present at the detected reference position, out of the image outputted from the image sensor 16, the imaging condition is adjusted.

Therefore, even in a case of a partial image that it is difficult to search directly, it is possible to adjust an imaging condition based on the partial image, and this serves to improve a capability of adjusting the imaging condition.

It is noted that in this embodiment, the beak of the small bird is the region where the AF process is to be performed; however, a site of the small bird other than the beak, for example, an ear covert, may be the region where the AF process is to be performed.

Furthermore, in this embodiment, a case where the small bird is photographed by using the digital camera 10 is used as an example. However, the present invention can be applied also to a case where another certain object that can be searched by using the dictionary image is photographed. For example, the present invention may be applied to a case of photographing an automobile, an airplane, and the like.

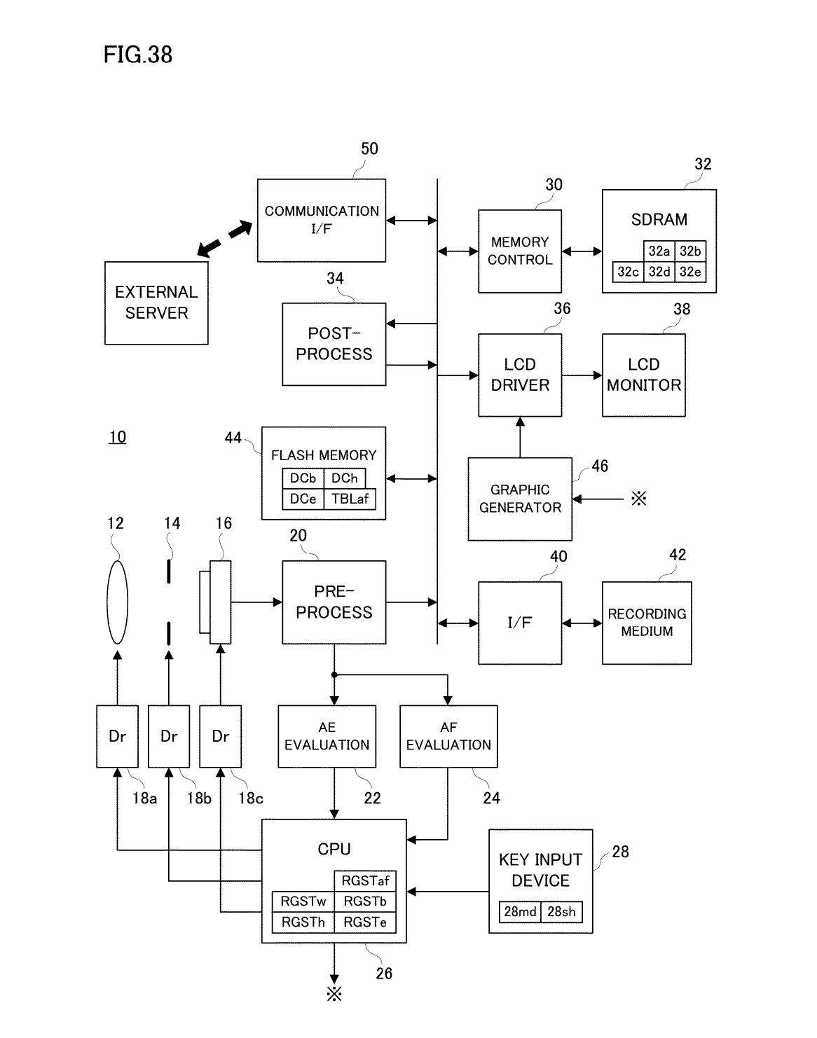

Furthermore, in this embodiment, a multi-task OS and the control program equivalent to a plurality of tasks executed by this are stored in the flash memory 44 in advance. However, a communication I/F 50 for a connection to an external server may be provided in the digital camera 10 as shown in FIG. 38, one portion of the control program may be prepared in the flash memory 44 as an internal control program from the beginning, and another portion of the control program may be acquired as an external control program from an external server. In this case, the above-described operations are implemented by the cooperation of the internal control program and the external control program.

Furthermore, in this embodiment, the process executed by the CPU 26 is divided into a plurality of tasks including the main task, the region registering task, the imaging task, and the small bird detecting task, which are shown in FIG. 24 to FIG. 37, respectively. However, these tasks may be further divided into a plurality of smaller tasks, and furthermore, one portion of the plurality of divided smaller tasks may be integrated with other tasks. Furthermore, when a transfer task is divided into a plurality of smaller tasks, the whole or one portion of the transfer tasks may be acquired from an external server. Furthermore, this embodiment is described using a digital still camera. However, the present invention can be applied to a digital video camera, a cellular phone, a smart phone, and the like.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager which repeatedly outputs an image representing a scene;
a register which registers relative position information in response to a registering operation;
a searcher which searches for a predetermined site image representing a predetermined site forming a specific object, from the image outputted from said imager;
a detector which detects a reference position on a specific object image appearing on the image outputted from said imager, based on the predetermined site image searched out by said searcher and the relative position information registered by said register; and
an adjuster which adjusts an imaging condition, based on a partial image present at the reference position detected by said detector out of the image outputted from said imager.

2. An electronic camera according to claim 1, further comprising a displayer which displays a dictionary image equivalent to the predetermined site, wherein said register registers, as the relative position information, a difference between a display position of the dictionary image displayed by said displayer and a position designated in association with the registering operation, and said searcher executes a searching process by using the dictionary image.

3. An electronic camera according to claim 2, wherein said detector includes: a calculator which calculates a disparity between a position of the predetermined site image and the reference position, based on a difference between a size of the predetermined site image searched out by said searcher and a size of the dictionary image displayed by said displayer, and the relative position information registered by said register; and a position detector which detects the reference position based on the disparity calculated by said calculator.

4. An electronic camera according to claim 1, wherein said searcher includes: an object searcher which searches for the specific object image representing the specific object, from the image outputted from said imager; and a site searcher which searches the predetermined site image, out of the specific object image discovered by said object searcher.

5. An electronic camera according to claim 1, wherein said imager has an imaging surface for capturing the scene through a focus lens, and said adjuster includes a distance adjuster which adjusts a distance from the focus lens to the imaging surface.

6. An imaging control program, which is recorded on a non-temporary recording medium in order to control an electronic camera provided with an imager which repeatedly outputs an image indicating a scene, causing a processor of the electronic camera to execute:
a registering step of registering relative position information in response to a registering operation;
a searching step of searching for a predetermined site image representing a predetermined site forming a specific object, from the image outputted from said imager;
a detecting step of detecting a reference position on the specific object image appearing on the image outputted from said imager, based on the predetermined site image searched out by said searching step and the relative position information registered by said registering step; and
an adjusting step of adjusting an imaging condition, based on a partial image present at the reference position detected by said detecting step out of the image outputted from said imager.

7. An imaging control method, which is executed by an electronic camera provided with an imager which repeatedly outputs an image indicating a scene, comprising:
a registering step of registering relative position information in response to a registering operation;
a searching step of searching for a predetermined site image representing a predetermined site forming a specific object, from the image outputted from said imager;
a detecting step of detecting a reference position on the specific object image appearing on the image outputted from said imager, based on the predetermined site image searched out by said searching step and the relative position information registered by said registering step; and
an adjusting step of adjusting an imaging condition, based on a partial image present at the reference position detected by said detecting step out of the image outputted from said imager.
